(19) United States
(12) Patent Application Publication
(10) Pub. No.: US 2007/0164119 A1
(43) Pub. Date: Jul. 19, 2007

(54) Electronic business card and data transceiver

(76) Inventors: Kwang Wang Liu, Sindian City (TW); Ko chin Shiao, Taoyuan City (TW)

Correspondence Address: PRO-TECHTOR INTERNATIONAL, 20775 Norada Court, Saratoga, CA, 95070-3018, US

(21) Appl. No.: 11/333,590

(22) Filed: Jan. 16, 2006

(51) Int. Cl. G06K 19/06; G06K 7/08

(52) U.S. Cl. 235/492; 235/451

(57) ABSTRACT

An electronic business card comprises an enlectonic card carrying an electronic circuit and an antenna and two protective layers. A data receiver/transmitter for exchanging data with the electronic business card comprises a sensor antenna and an electronic circuit having a driver/amplifier-modulation/demodulation circuit, a memory circuit, a first input/output circuit, a second input/output circuit and a central processing unit.

### BACKGROUND OF THE INVENTION

1. Field of the Invention

The present invention relates to an electronic business card and data transceiver.

2. Description of Related Art

Business cards provide personal information to other people using text or graphics, serving as an important tool of presenting oneself to others. Printed business cards, however, which are printed in large quantities, need to be discarded and printed anew if any change of contents occurs, which is wasteful and harmful to the environment. Furthermore, keying-in data of a received business card to store them electronically requires considerable time and is fraught with the risk of typing errors, which in the case of foreigners happen easily. If the same data need to be stored in various electronic devices, like computers or mobile phones, repeated typing is cumbersome. On the other hand, electronically stored data are readily processed, e.g. translated, stored and printed. An electronic business card after reading out data is handed back to the owner and is re-usable an unlimited number of times, saving cost and environmental resources.

It is well known that digital data coding text, pictures and audio are transmittable between various devices fast and without losses. Input, output and transmission is handles by software, as is widely used in personal computers mobile phones and personal digital assistants.

With improving semiconductor technology, storage volumina are decreasing, while stored quantities are increasing, having reached hundreds of megabytes in small portable devices. Microprocessors, circuits and interfaces have been combined on single chips for ready applicability on chip cards. Easy readability of chip cards allows for wide applications thereof.

### SUMMARY OF THE INVENTION

An object of the present invention is to provide an electronic business card and data receiver/transmitter for digital storing of data.

Another object of the present invention is to provide an electronic business card and data receiver/transmitter, which reads out digitally stored data.

A further object of the present invention is to provide an electronic business card and data receiver/transmitter, which integrates digital storing and reading out of data in a single device.

The present invention can be more fully understood by reference to the following description and accompanying drawings.

### DETAILED DESCRIPTION OF THE PREFERRED EMBODIMENTS

As shown in FIG. 1, the electronic business card and data transceiver of the present invention comprises an electronic card 10 and a radio frequency transceiver 11. The radio frequency transceiver 11 transmits radio frequency waves 12 which are received by the electronic card 10. The electronic card 10 in turn transmits signals on radio frequency waves 13 which are received by the transceiver 11. The transceiver 11 has an interface 14 for connecting to other digital devices, so as to have data stored therein.

Referring to FIG. 2, the electronic card 10 has a front side and a back side on which protective layers 21, 21a of sufficient strength are printed. Between the protective layers 21, 21a, a middle layer made of soft plastics is inserted, carrying an electronic circuit 22. The electronic circuit 22 comprises a control/storage circuit 23, an antenna 24 and contact terminals 25. Within the protective layer 21a, a space 26 is left for accommodating the electronic circuit 22. After gluing the plastics layer and the protective layers 21, 21a, a stable card with smooth surfacesis created, which resembles a regular plastics card.

The antenna 24 works as a sensor. As shown in FIGS. 2-3, when the electronic card is hit by radio waves of a certain frequency, an electric voltage is generated on terminals of the antenna 24. A watchdog and regulator circuit 33 works as a switch, so that electric power is provided for the entire system, and is further connected with a modulation/demodulation circuit 32, so that sending of strings of data is enabled. Furthermore, a bidirectional interface 34, central processing unit 35, a timer circuit 36, and, via a memory managing unit 37, a memory circuit 38 are connected therewith and with each other. The contact terminals 25 are connected with the bidirectional interface 34. The antenna 24 and the contact terminals 25 are able simultaneously to receive and transmit data. The memory circuit 38 is a read-only memory or is a rewritable flash memory for storing text, audio and pictures data.

The chips used on the electronic card are low power and high speed silicon chips. The antenna 24 is highly effective. It works as a secondary winding of a air-cored power transformer which generates power to supply the system chips, so that no power source, particularly no battery, is required. Thereby the electronic card 10 works maintenance-free, like a regular plastic card, in particular, having any desired shape and being printed on with any desired text or pattern.

Referring to FIG. 4, the transceiver 11 comprises: a sensor antenna 42 for sending signals to the electronic card 10 and receiving signals therefrom; an electronic circuit 43; an interface cable 44 having a connector 46 at a far end thereof, an upper cover 41; and a lower cover 45. The upper cover 41 and the lower cover 45 protect the electronic circuit 43 and serve to provide a beautiful appearance. The sensor antenna 42 and the electronic circuit 43 are combined on a flexible or regular printed circuit, saving space and manufacturing cost.

Referring to FIG. 5, the sensor antenna 42 serves to transmit and receive signals and also works as a primary winding of an air-cored power transformer providing magnetic flux to the antenna of the electronic business card. A driver-amplifier/modulation/demodulation circuit 52 amplifies and modulates or demodulates signals. A central processing unit 53 processes data Signals are stored in a memory circuit 54. A first input/output circuit 55 transmits signals between the memory circuit 54 and, via a cable terminal 58, an external device. A second input/output circuit 56 transmits signals via a cable terminal 57 from and to the electronic card 10.

The radio receiver/transmitter 11 is able to send out stored data to a digital device for further processing. Data received from the electronic card 10 are organizable in fields with defined lengths, e.g., fields containing total length, language, nation, further attributes etc. and a final checksum. Pictures and graphic designs are storable, with every combination of data representing one electronic card. Greetings, melodies, cartoons and presentations of products and services are storable, with limits only given by memory size. Memory size, however, is increasing rapidly with progress of technology.

Electronic components on the electronic card 10 and the transceiver 11 are similar, so mostly equal circuit components are used. A bidirectional antenna is used, and the direction of data flow can be controlled by an I/O bit or by operation software, thus both functions can be performed by a single circuit.

Referring to FIG. 6, in an embodiment with double functions, the present invention comprises: an electronic circuit board 61; an interface cable 62 having a connector 65 at a far end thereof; a cover 63; and a bottom 64. When the circuit board 61 is built into another device, the cover 63 and the bottom 64 are optional.

Referring to the functional block of such combination in FIG. 7, an antenna 71 serves to receive and transmit radio frequency signals, the function of the antenna as a primary winding can be switched ON and OFF by a switch 73 and a timer circuit 76. A bi-directional interface 72 controls a direction of data flow for the antenna 71. Furthermore, a first interface 74 allows to receive data from contact terminals 710 and to transmit data thereto. A central processing unit 75 performs data processing. A memory circuit 78, which is an EEPROM or a flash memory component, is via a memory management unit 77 connected to the central processing unit 75. A second interface 79 allows to transmit and receive data to and from a connector 711.

Using a combined electronic business card and data transceiver receiver/transmitter 81 in conjunction connected with another digital device 82, as shown in FIG. 8, allows using capabilities thereof to read data without additional devices, as well as receiving and transmitting of data.

As above explanation shows, the electronic card and receiver/tansmitter of the present invention is accommodated in a small volume, being either housed in an own case or been built into another device.

The present invention offers the following advantages:
1. Error-free transmission and storage of data.
2. Re-usability, saving environmental and economic resources.
3. Usability with other digital devices in a single case.
4. By employing software, display of foreign-language texts in a language of choice.
5. Free formatting of data for ready creating of lists of persons or clients.
6. Storability of additional data, e.g., greetings, presentations or melodies.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a perspective view of the present invention.

FIG. 2 is a perspective view of the electronic card of the present invention when disassembled.

FIG. 3 is a circuit diagram of the electronic card of the present invention.

FIG. 4 is a perspective view of the radio receiver/transmitter of the present invention when disassembled.

FIG. 5 is a circuit diagram of the radio receiver/transmitter of the present invention.

FIG. 6 is a perspective view of the present invention in another embodiment when disassembled.

FIG. 7 is a circuit diagram of the present invention in another embodiment.

FIG. 8 is a perspective view of the present invention in another embodiment in conjunction with a digital device.

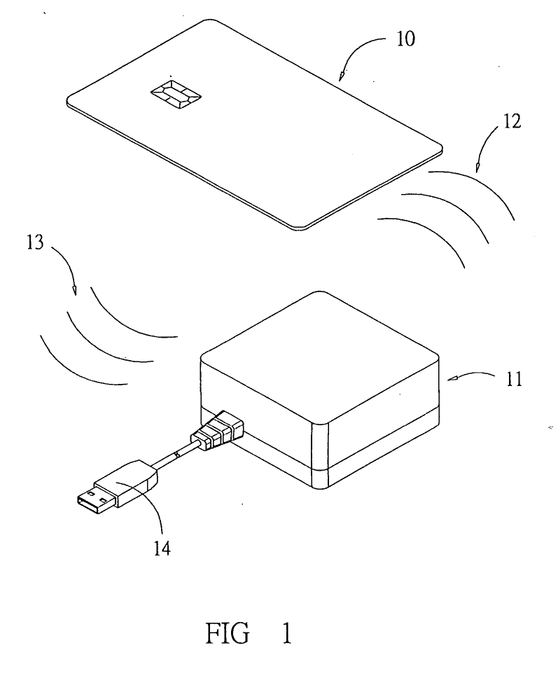

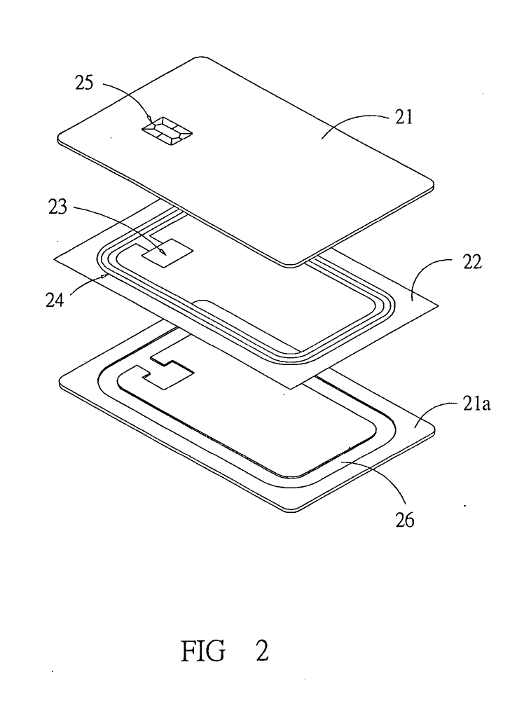

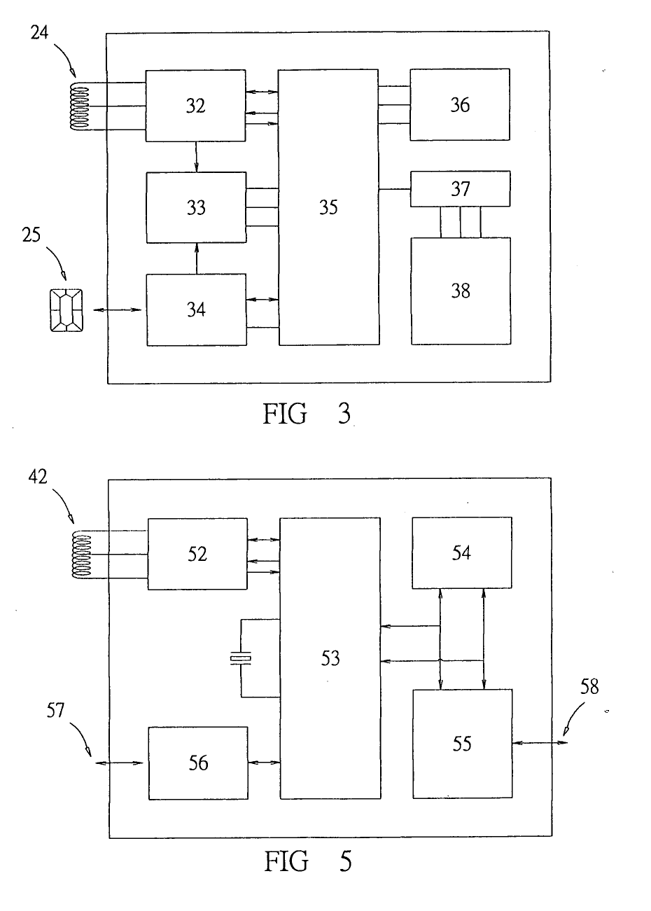

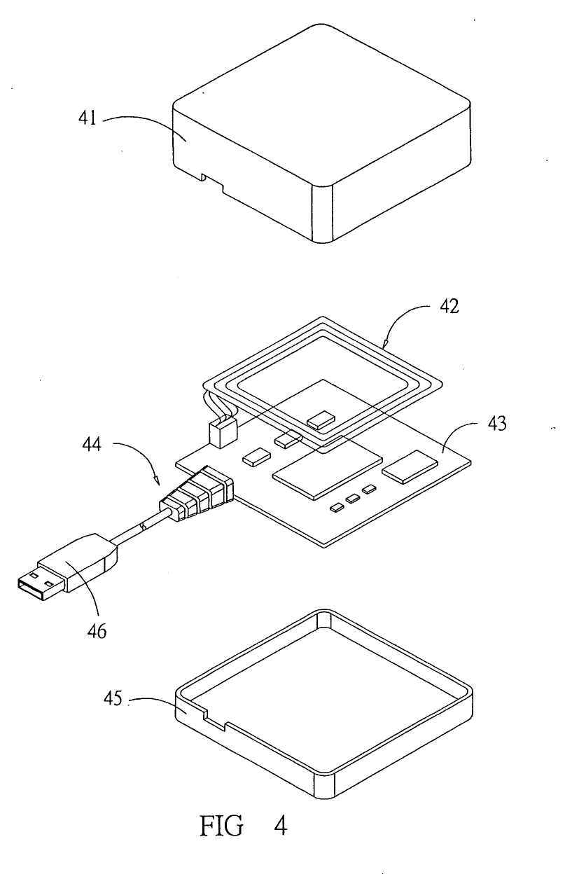

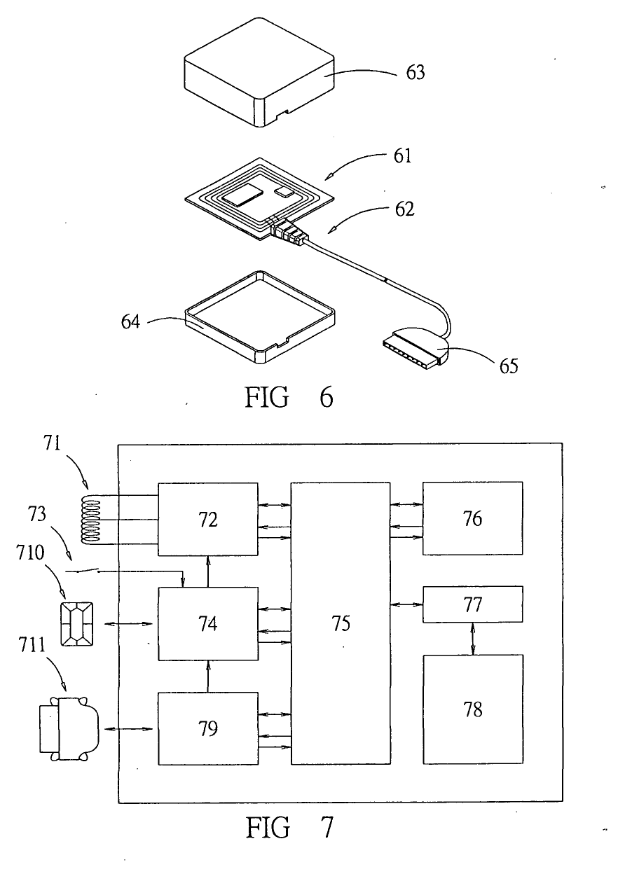

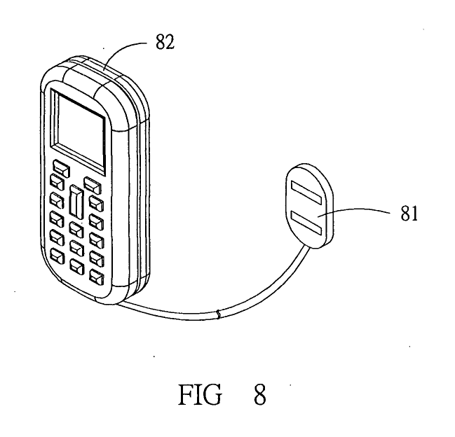

1. An electronic business card, comprising a middle layer carrying an electronic circuit holding data, and protective layers, covering said middle layer.

2. The electronic business card according to claim 1, wherein said antenna works as a sensor which, upon sensing an external signal, generates electric power for transmitting data on said electronic business card.

3. The electronic business card according to claim 1, wherein said electronic circuit further comprises:
a power generator/regulator with a watchdog circuit for activating said electronic business card;
a memory circuit, storing data;
a modulation/demodulation circuit, modulating and demodulating data that are sent through or received from said antenna;
a bidirectional interface, receiving data for storage and transmitting stored data;
a timer circuit, generating a system clock and timer signal;
a memory management unit, controlling said memory circuit; and
a central processing unit, controlling said watchdog circuit, said modulation/demodulation circuit, said bidirectional interface, said timer circuit and said memory management unit, and performing processing of data.

4. The electronic business card according to claim 3, wherein said bidirectional interface receives and transmits digital signals.

5. The electronic business card according to claim 3, wherein said bidirectional interface has contact terminals for connecting to an external device.

6. The electronic business card according to claim 5, wherein said contact terminals pass through one of said protective layers.

7. The electronic business card according to claim 1, wherein said protective layers are made of printable plastic and cover both sides of said middle layer.

8. The electronic business card according to claim 1, wherein said protective layers leave space for accommodating said electronic circuit and have smooth outer surfaces.

9. The electronic business card according to claim 1, wherein data held by said electronic circuit are text data, audio data or image data.

10. The electronic business card according to claim 3, wherein said memory circuit is writable once or repeatedly.

11. A data transceiver for an electronic business card, comprising a sensor antenna for receiving signals from and transmitting signals to said electronic business card and an electronic circuit, further comprising:
a driver/amplifier-modulation/demodulation circuit, amplifying, modulating and demodulating signals received by said sensor antenna data;
a memory circuit, storing data from driver/amplifier-modulation/demodulation circuit;
a first input/output circuit, transmitting signals between said memory circuit and an external device;
a second input/output circuit, transmitting signals via a cable terminal to said electronic business card;
a central processing unit, controlling said driver/amplifier-modulation/demodulation circuit, said memory circuit, said first input/output circuit and said second input/output circuit, and performing processing of data.

12. The data transceiver for an electronic business card according to claim 11, further comprising an upper cover and a lower cover protecting said sensor antenna and said electronic circuit.

13. The data transceiver for an electronic business card according to claim 11, wherein said sensor antenna and said electronic circuit are placed on a single printed circuit board.

14. The data transceiver for an electronic business card according to claim 11, wherein said first input/output circuit has wire terminals for connecting to an external device and said second input/output circuit has contact terminals.

15. The data transceiver for an electronic business card according to claim 11, which is built into another digital apparatus.

16. An electronic business card with data transceiver, comprising:
a sensor antenna, for receiving and transmitting signals that are stored imnternally;
a bidirectional interface, performing receiving and transmitting of data through said sensor antenna;
a first interface with contact terminals, transmitting data from and to an external device;
a timer circuit, generating a timer signal;
a memory circuit, storing data;
a memory management unit, controlling said memory circuit;
a second interface with a connector, transmitting data from and to an external device; and
a central processing unit, controlling said bidirectional interface, said first interface, said timer circuit, said memory management unit and said second interface, and performing processing of data.

17. The electronic business card with data transceiver according to claim 16, wherein operation of said sensor antenna is controlled by a hardware switch pin or said timer circuit an I-O bit from the digital I-O port.

18. The electronic business card with data transceiver according to claim 16, further comprising a case for protecting said sensor antenna and electronic components.

19. The electronic business card with data transceiver according to claim 16, which is used inside another digital device or apparatus.

20. The electronic business card with data transceiver according to claim 16, wherein said first interface is a standard interface or for a dedicated system if required.
